(19) United States
(12) Patent Application Publication
(10) Pub. No.: US 2004/0228505 A1
(43) Pub. Date: Nov. 18, 2004

(54) Image characteristic portion extraction method, computer readable medium, and data collection and processing device

(75) Inventor: Masahiko Sugimoto, Saitama (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 10/822,003

(22) Filed: Apr. 12, 2004

(30) Foreign Application Priority Data
Apr. 14, 2003 (JP) P.2003-109177
Apr. 14, 2003 (JP) P.2003-109178
Mar. 17, 2004 (JP) P.2004-076073

(51) Int. Cl. G06K 9/00; G06K 9/62

(52) U.S. Cl. 382/118; 382/209

(57) ABSTRACT

A method for detecting whether an image of a characteristic portion exists in an image to be processed, comprising: sequentially cutting images of a required size from the image to be processed; and comparing the cut images with verification data corresponding to the image of the characteristic portion, wherein a limitation is imposed on a size range of the image of the characteristic portion with reference to the size of the image to be processed, based on information about a distance between a subject and a location of the subject, obtained when the image to be processed has been photographed, thereby limiting the size of the cut images to be compared with the verification data.

### BACKGROUND OF THE INVENTION

1. Field of the Invention

The present invention relates to a method for extracting a characteristic portion of an image, which enables a determination of whether a characteristic portion of an image such as a face is present in an image to be processed, and high-speed extraction of the characteristic portion, as well as to an imaging device and an image processing device. The present invention also relates to a method for extracting a characteristic portion of an image, such as a face, from a continuous image such as a continuously-shot image or a bracket-shot image, as well as to an imaging device and an image processing device. The foregoing methods may be implemented as a set of computer-readable instructions stored in a computer readable medium such as a data carrier.

2. Description of the Related Art

For instance, as described in JP-2001-A-215403, some digital cameras are equipped with an auto focusing device which extracts a face portion of a subject and automatically sets the focus of the digital camera on eyes of the thus-extracted face portion. However, JP-2001-A-215403 describes only a technique for achieving focus and fails to provide descriptions about the method of extracting the face portion of the subject, which method enables high-speed extraction of a face image.

When a face portion is extracted from the screen, template matching is employed in the related art. Specifically, the degree of similarity between images sequentially cut off from an image of a subject by means of a search window and a face template is sequentially determined. The face of the subject is determined to be situated at the position of the search window where the cut image coincides with the face template at a threshold degree of similarity or more.

In the related art, when the template matching is performed, the size at which the face of the subject appears on a screen is uncertain. Therefore, a plurality of templates of different sizes ranging from a small face template to a face template filling the screen are prepared before hand and stored in a memory device, and template matching is performed through use of all templates, to thus extract a face image.

### SUMMARY OF THE INVENTION

If the characteristic portion of the subject, such as a face or the like, could be extracted before photographing, numerous advantages would be yielded; that is, the ability to shorten a time which lapses before a focus is automatically set on the face of the subject and the ability to achieve white balance so as to match the flesh color of the face. Further, when photographed image data is loaded into a processor such as a personal computer or the like and manually subjected to image processing by a user, so long as the position of the face of the subject within the image has been extracted in advance by a controller, the controller can provide the user with an appropriate guide through, e.g., adjustment of flesh color or the like.

However, there is a related art need for preparing a plurality of face templates from small templates to large ones and perform matching operation using the templates, which raises a related art problem of much time being consumed by extracting a face. In addition, when a plurality of template images are prepared in memory, the storage capacity of the memory is increased, thereby raising a related art problem of a hike in costs of the camera.

The foregoing example is directed toward a case where a person is photographed by a camera, such as when an image to be processed is loaded into the camera from an image processing device or printer; when a determination is made as to whether or not a face of that person is present in the image; and when the image is subjected to image correction to match flesh color or when red eyes stemming from flash light are corrected, convenience is achieved if high-speed extraction of a characteristic portion, such as a face, is possible.

An object of the present invention is to provide an image characteristic portion extraction method to enable high-speed and highly-accurate extraction of a characteristic portion, such as a face but not limited thereto, of an image to be processed, as well as to provide an imaging device and an image processing device. The processor may be remote or positioned the imaging or the image processing device.

The present invention provides an image characteristic portion extraction method for detecting whether or not an image of a characteristic portion exists in an image to be processed, by means of sequentially cutting images of required size from the image to be processed, and comparing the cut images with verification data pertaining to the image of the characteristic portion, wherein a size range of the image of the characteristic portion with reference to the size of the image to be processed is limited on the basis of information about a distance to the subject obtained when the image to be processed has been photographed, thereby limiting the size of the cut images to be compared with the verification data.

This configuration reduces the necessary processing for cutting a fragmentary image from the image to be processed, the fragmentary image being drastically larger or smaller than the size of an image of a characteristic portion, and comparing the thus-cut image with verification data, thereby shortening a processing time. Moreover, the verification data to be used and the size of an image to be cut are limited on the basis of information about a distance, and hence erroneous detection of an extraneously-large semblance of a characteristic portion (e.g., a face) as a characteristic portion is prevented.

The comparison employed in the image characteristic portion extraction method of the present invention is characterized by being effected through use of a resized image into which the image to be processed has been resized.

By means of this configuration, extraction of a face image varying from person to person without regard to a difference between individuals is facilitated.

The limitation employed in the image characteristic portion extraction method of the present invention is characterized by being effected through use of information about a focal length of a photographing lens in addition to the information about a distance to the subject.

By means of this configuration, a highly-accurate limitation can be imposed on a range which covers a characteristic portion (e.g., a face).

The comparison employed in the image characteristic portion extraction method of the present invention is characterized by being effected through use of the verification data corresponding to an image of a characteristic portion of determined size, by means of changing the size of the resized image. Conversely, the comparison employed in the image characteristic portion extraction method is characterized by use of the verification data, the data being obtained by having changed the size of the image of the characteristic portion while the size of the resized image is fixed.

By means of this configuration, high-speed extraction of the image of the characteristic portion becomes possible.

The verification data of the image characteristic portion extraction method is characterized by being template image data pertaining to the image of the characteristic portion.

When an image of a characteristic portion; e.g., a face image, is extracted through use of the template image data, preparation of a plurality of types of template image data sets is preferable. For example but not by way of limitation, a template of a person wearing eyeglasses, a template of a face of an old person, and a template of a face of an infant, as well as a template of an ordinary person, are prepared, thereby enabling highly-accurate extraction of an image of a face.

The verification data employed in the image characteristic portion extraction method is prepared by converting the amount of characteristic data of the image of the characteristic portion into digital data, such as numerals.

The verification data that have been converted into numerals are data prepared by converting, into numerals, pixel values (density values) obtained at respective positions of the pixels of the image of the characteristic portion. Alternatively, the verification data are data obtained as a result of a computer having learned face images through use a machine learning algorithm such as a neural network or a genetic algorithm. Even in this case, as in the case of the template images, preparation of various types of data sets; that is, verification data pertaining to a person wearing eyeglasses, verification data pertaining to an old person, verification data pertaining to an infant, as well as verification data pertaining to an ordinary person, is preferable. Since the verification data has been converted into digital data, the storage capacity of memory is not increased even when a plurality of types of verification data sets are prepared.

The verification data employed in the image characteristic portion extraction method are characterized by being formed from data into which are described rules to be used for extracting the amount of characteristic of the image of the characteristic portion.

By this configuration, as in the case of the data that have been converted into numerals, a limitation is imposed on the search range of an image to be processed in which an image of a characteristic portion is to be retrieved, and hence high-speed extraction of an image of a characteristic portion can be performed.

The image characteristic portion extraction method comprises limiting a range in which an image of a characteristic portion of a second image to be processed followed by a first image to be processed is retrieved, through use of information about the position of a characteristic portion extracted from the first image. The information is obtained by the image characteristic portion extraction method.

By this configuration, an image of a characteristic portion of a subject is retrieved within a limited range in which the image of the characteristic portion of the subject exists with high probability, and hence the characteristic portion can be extracted at a high speed. Moreover, occurrence of faulty detection can be prevented by means of limiting the retrieval range. Specifically, erroneous detection of an extraneously large semblance of a characteristic portion (e.g., a face) as a characteristic portion can be prevented.

The present invention includes a set of instructions in a computer-readable medium for executing the methods of the present invention. These instructions include a characteristic portion extraction program for detecting whether or not an image of a characteristic portion exists in an image to be processed, and comprise: sequentially cutting images of required size from the image to be processed; and comparing the cut images with verification data pertaining to the image of the characteristic portion. The instructions include limiting a size range of the image of the characteristic portion with reference to the size of the image to be processed, based on information about a distance to a subject obtained when the image to be processed has been photographed, thereby limiting the size of the cut images.

As a result of the foregoing instructions for the image characteristic portion extraction program, equipment provided with a computer can be caused to execute the instructions, and hence various manners of utilization of the program become possible. For example, but not by way of limitation, the processing can be performed in the imaging device, an image processing device, or remotely from such devices, as would be understood by one skilled in the art.

The present invention also includes a set of instructions stored in a computer readable medium for characteristic portion extraction, comprising limiting a range in which an image of a characteristic portion of a second image to be processed followed by a first image to be processed is retrieved through use of information about the position of a characteristic portion extracted from the first image. The information is obtained by the program of the characteristic portion extraction program. As noted above, these instructions can be stored in a computer readable medium in a number of devices, or remotely therefrom.

By means of this configuration, an image of a characteristic portion of a subject is retrieved within a limiting range where the image exists with high probability, and hence the characteristic portion can be extracted at high speed.

The present invention provides an image processing device characterized by being loaded with the previously-described characteristic portion extraction instructions. By means of this configuration, the image processing device becomes able to perform various types of correction operations. For example but not by way of limitation, brightness correction, color correction, contour correction, halftone correction, imperfection correction can be performed. These correction operations are not necessarily applied to the entire image and may include operations for correcting a local area in the image.

The distance information to be used when the characteristic portion extraction program stored in the image processing device executes the step corresponds to distance information added to the image to be processed as tag information.

If the distance information has been appended to the image to be processed as tag information, the image processing device can readily compute the size of the image of the characteristic portion within the image to be processed, whereby the search range can be narrowed.

The present invention provides an imaging device comprising: the characteristic portion extraction program; and means for determining the distance information required at the time of execution of the step of the characteristic portion extraction program according to the above-described method steps or instructions.

By means of this configuration, the imaging device can set the focus on a characteristic portion, e.g., the face of a person, during photographing or can output image data which have been corrected such that flesh color of the face becomes clear.

The means for determining the distance information of the imaging device corresponds to any one of a range sensor, means for counting the number of motor drive pulses arising when the focus of a photographing lens is set on a subject, and means for determining information about a focal length of the photographing lens, unit for estimating a distance to the subject based on a photographing mode (e.g., a portrait photographing mode, a landscape photographing mode, a macro photographing mode or the like) and a unit for estimating a distance to the subject based on a focal length of a photographing lens.

Distance information can be acquired by utilization of a range sensor usually mounted on an imaging device, a focus setting motor of a photography lens, or the like, and hence a hike in costs of the imaging device can be reduced. Even when the imaging device is not equipped with the range sensor or the pulse counting means, a rough distance to a subject can be estimated from a photographing mode or focal length information about the photographing lens. Hence, the size of the characteristic portion (e.g., a face) included in a photographed image can be estimated to a certain extent, and hence a range of size of the characteristic portion to be extracted can be limited by such an estimation.

### BRIEF DESCRIPTION OF THE DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a block diagram of a digital still camera according to a first exemplary, non-limiting embodiment of the invention;

FIG. 2 is an exemplary, non-limiting flowchart showing a processing method that may be included in a face extraction program loaded in the digital still camera shown in FIG. 1;

FIG. 3 is a descriptive view of scanning performed by a search window of the present invention;

FIG. 4 is a view showing an exemplary, non-limiting face template of the present invention;

FIG. 5 is a descriptive view of an example for changing the size of the search window of the present invention;

FIG. 6 is a descriptive view of an example for changing the size of a template according to an exemplary, non-limiting embodiment of the present invention;

FIG. 7 is a flowchart showing an exemplary, non-limiting method of a set of instructions corresponding to face extraction program that may be loaded in the digital still camera shown in FIG. 1;

FIG. 8 is a descriptive view of continuously-input images and a search range;

FIG. 9 is a flowchart showing an exemplary, non-limiting method for face extraction as may be stored as a set of instructions in a computer readable medium according to a second exemplary, non-limiting embodiment of the present invention;

FIG. 10 is a view showing an example arrangement of a digital still camera according to a third exemplary, non-limiting embodiment of the present invention;

FIG. 11 is a flowchart showing processing procedures of a face extraction program according to a third exemplary, non-limiting embodiment of the present invention;

FIG. 12 is a flowchart showing processing procedures of a face extraction program according to a fourth exemplary, non-limiting embodiment of the present invention; and

FIG. 13 is a descriptive view of verification data according to a fifth exemplary, non-limiting embodiment of the invention.

### DETAILED DESCRIPTION OF THE INVENTION

Embodiments of the present invention will be described hereinbelow by reference to the drawings. Explanations are herein given to, as an example, an image characteristic portion extraction method to be executed by set of instructions loaded in a computer readable medium that may be positioned in a data capture element such as a digital camera which is a kind of imaging device. A similar advantage can be yielded by means of loading the same characteristic portion extraction program in an image processing device, including a printer, or an imaging device.

(First Embodiment)

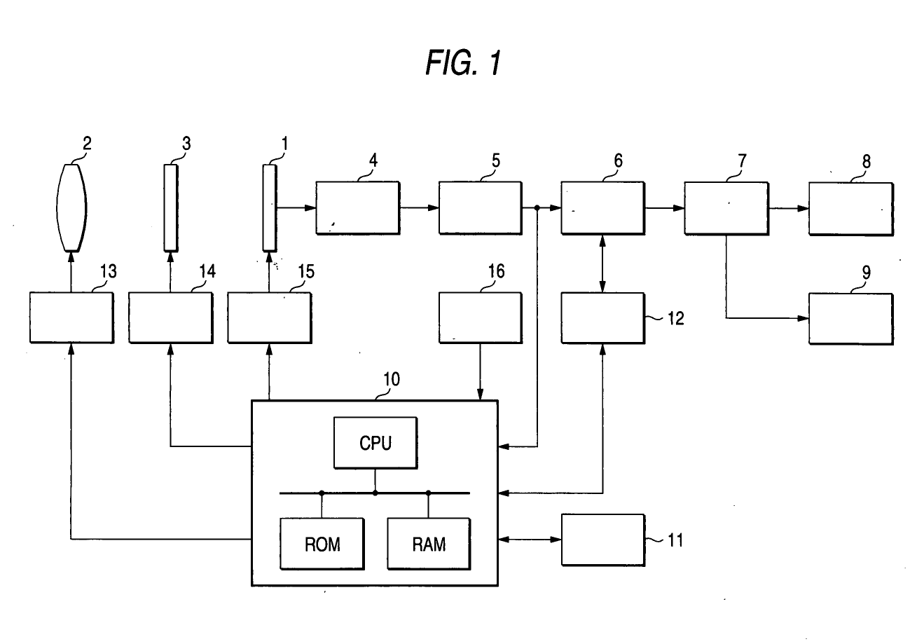

FIG. 1 is a block diagram of a digital still camera according to a first exemplary, non-limiting embodiment of the present invention. The digital still camera comprises a solid-state imaging element 1, such as a CCD or a CMOS but not limited thereto; a lens 2 and a diaphragm 3 disposed in front of the solid-state imaging element 1; an analog signal processing section 4 for subjecting an image signal output from the solid-state imaging element 1 to correlation double sampling or the like; an analog-to-digital conversion section 5 for converting, into a digital signal, the image signal that has undergone analog signal processing; a digital signal processing section 6 for subjecting the image signal, which has been converted into a digital signal, to gamma correction and synchronizing operation; image memory 7 for storing the image signal processed by the digital signal processing section 6; a recording section 8 for recording in external memory or the like an image signal (photographed data) stored in the image memory 7 when the user has pressed a shutter button; and a display section 9 for through displaying the contents stored in the image memory 7 and provided on the back of the camera.

This digital still camera further comprises a control circuit 10 constituted of a CPU, ROM, and RAM; an operation section 11 which receives a command input by the user and causes the display section 9 to perform on-demand display processing; a face extraction processing section 12 for capturing the image signal that has been output from the imaging element 1 and processed by the digital signal processing section 6 and extracting a characteristic portion of a subject; that is, a face in the embodiment, in accordance with the command from the control circuit 10, as will be described in detail later; a lens drive section 13 for setting the focus of the lens 2 and controlling a magnification of the same in accordance with the command signal output from the control circuit 10; a diaphragm drive section 14 for controlling the aperture size of the diaphragm 3; an imaging element control section 15 for driving and controlling the solid-state imaging element 1 in accordance with the command signal output from the control circuit 10; and a ranging sensor 16 for measuring the distance to the subject in accordance with the command signal output from the control circuit 10.

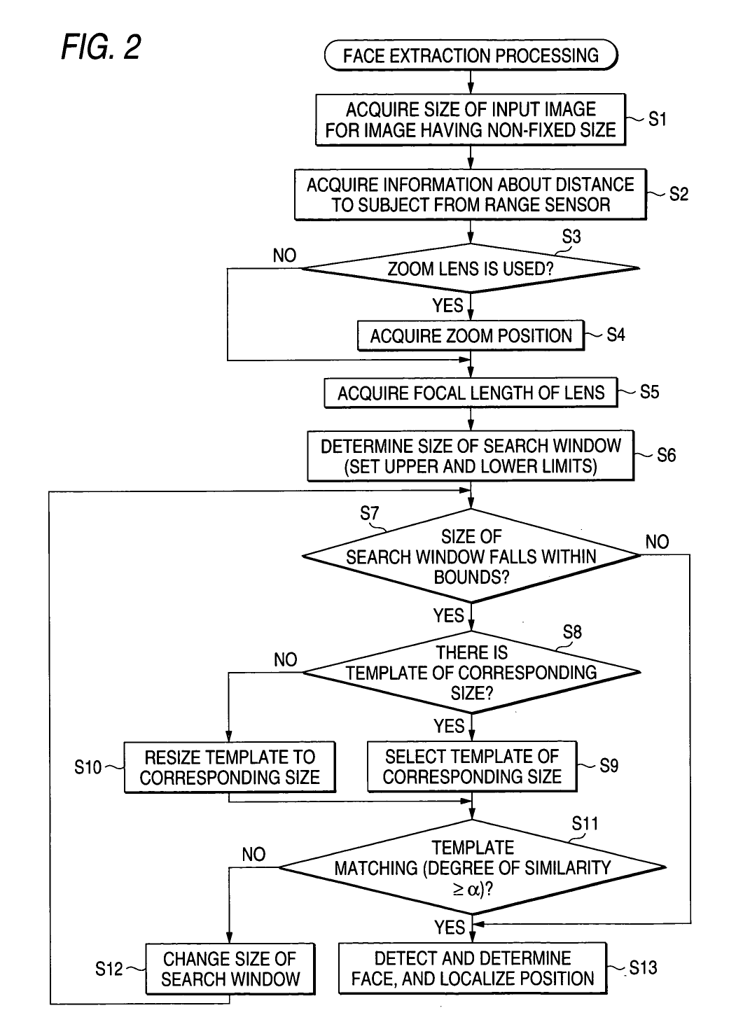

FIG. 2 is a flowchart of a method according to an exemplary, non-limiting embodiment of the present invention. For example, procedures for the face extraction processing section 12 to perform face extraction processing are provided. However, the method need not be performed in this portion of the device illustrated in FIG. 1, and if the data is provided, such a program may operate as a stand-alone method in a processor having a data carrier.

In one exemplary embodiment of the present invention, the face extraction program is stored in the ROM of the control circuit 10 shown in FIG. 1. As a result of the CPU loading the face extraction program into the RAM and executing the program, the face extraction processing section 12 performs the steps of the method. It is noted that as used above, the “command signal output” actually way refer to a plurality of command signals, each of which is transmitted to respective components of the system. For example, but not by way of limitation, a first command signal may be sent to the face extraction processing section 12, and a second command signal may be sent to the ranging sensor 16.

The imaging element 1 of the digital still camera outputs an image signal periodically before the user presses a shutter button. The digital signal processing section 6 subjects respective received image signals to digital signal processing. The face extraction processing section 12 sequentially captures the image signal and subjects input images (for example but not by way of limitation, photographed images) to at least the following processing steps.

The size of an input image (an image to be processed) is acquired (step S1) When a camera having a different sized input image for face extraction processing depending on the resolution at which the user attempts to photograph an image (e.g., 640×480 pixels or 1280×960 pixels), size information is acquired. When the size of the input image is fixed, step S1 is unnecessary.

Next, information about a parameter indicative of the relationship between the imaging device and the subject to be imaged, such as the distance to the subject, is measured by the ranging sensor 16. For example, this ranging information is provided to the control circuit 10 (step S2).

When an imaging device not equipped with the range sensor 16 has a mechanism for focusing on the subject by actuating a focal lens back and forth through motor driving action, the number of motor drive pulses is counted, and distance information can be determined from the count. In this case, a relationship between the pulse count and the distance may be provided as a function or table data.

In step S3, a determination is made as to whether or not a zoom lens is used. When the zoom lens is used, zoom position information is acquired from the control circuit 10 (step S4). Focal length information about the lens is then acquired from the control circuit 10 (step S5). When in step S3 the zoom lens is determined not to be used, processing proceeds to step S5, bypassing step S4.

From the input image size information and the lens focal length information a determination can be made as to the size to be attained by a face of the subject in the input image. Therefore, in the step S6, upper and lower limitations on the size of a search window conforming to the size of the face are determined. This step is described in greater detail below.

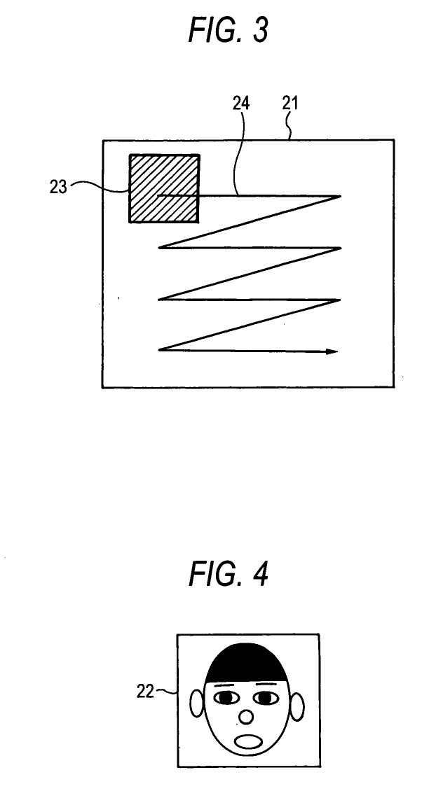

As shown in FIG. 3, the search window is a window 23 whose size is identical with the size of a face image with reference to a processing image 21 to be subjected to template matching; that is, the size of a template 22 shown in FIG. 4. A normalizing cross-correlation function, or the like, between the image cut by the search window 23 and the template 22 is determined through the following processing steps to compute the degree of matching or degree of similarity. When the degree of matching fails to reach a threshold value, the search window 23 is shifted in a scanning direction 24 by a given number of pixels; e.g., one pixel over the processing image 21 to cut an image for the next matching operation.

The processing image 21 is an image obtained by resizing an input image. Detection of a common “face” in due to lack of dissimilarity between individuals is facilitated by performing a matching operation while taking as a processing image an image formed by resizing the input image to, e.g., 200×150 pixels, (as a matter of course, a face image having few pixels; e.g., 20×20 pixels, rather than a high-resolution face image is used for the template face image) rather than performing a matching operation while taking a high-resolution input image of, e.g., 1200×960 pixels, as a processing image.

In the next step S7, a determination is made as to whether or not the size of the search window falls within bounds defined by the upper and lower limitations on the size of the face within the processing image 21. If the size of the search window does not fall within the above-described bounds, then step S13 is performed as disclosed below. However, if the size of the search window falls within the bounds, then step S8 is performed as disclosed below.

In step S8, a determination is made as to whether a template 22 conforms in size to the search window 23 (step S8). When such a conforming template exists, the corresponding template is selected (step S9).

When no such template exists, the template is resized to generate a template conforming in size to the search window 23 (step S10), and processing proceeds to step S11.

In step S11, template matching is performed while the search window 23 is scanned in the scanning direction 24 (FIG. 3) to determine whether an image portion has a degree of similarity that exceeds the threshold value by α or more.

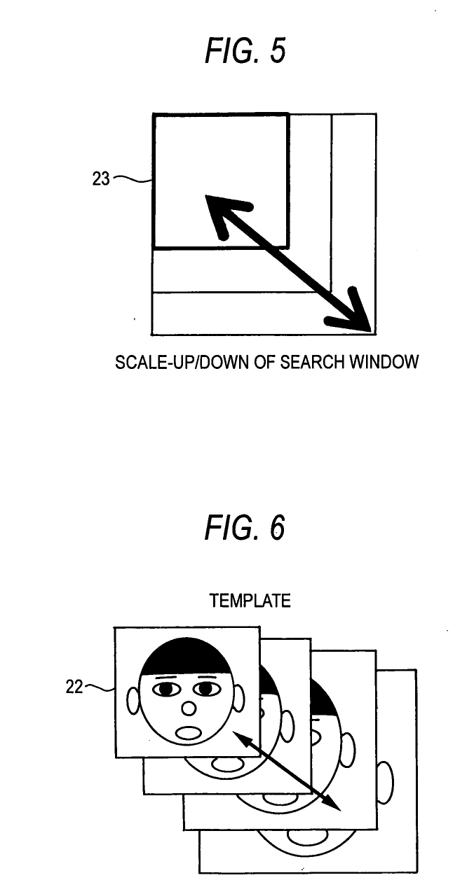

When no image portion whose degree of similarity has the threshold value of α or more, processing proceeds to step S12, where the size of the search window 23 is changed in the manner shown in FIG. 5. The size of the search window 23 to be used is determined, and then processing proceeds to step S7. Hereinafter, processing repeatedly proceeds in sequence of step S7-S11 until the “yes” condition in step S11 is satisfied.

As mentioned above, in the present embodiment, the size of the template is changed in the manner shown in FIG. 6 while the size of the search window 23 is changed from the upper limitation to the lower limitation (or vice versa) in the manner as shown in FIG. 5, thereby repeating template matching operation.

When in step S11 an image portion whose degree of similarity is equal to the threshold value a or more has been detected, processing proceeds to face detection determination processing pertaining to step S13, thereby locating the position of the face. Information about the position of the face is output to the control circuit 10, whereupon the face detection processing is completed.

When the size of the search window 23 has gone beyond the bounds defined by the upper and lower limitations as a result of processing being repeated in sequence of steps S7-S12, . . . a result of determination rendered in step S7 becomes negative (N). In this case, processing proceeds to face detection determination processing pertaining to step S13, where the determination is performed, and the result of the determination is that “no face” is detected.

In the present embodiment, the processing system is characterized by placing an emphasis on a processing speed. Hence, when in step S11 an image portion whose degree of similarity is equal to the threshold value a or more has been detected; that is, when an image of one person has been extracted, processing immediately proceeds to step S13, where the operation for retrieving a face image is completed.

However, when there is realized a processing system in which emphasis is placed on the accuracy of detection of a face image, all the cut images are compared with all the templates, to thus determine the degrees of similarity. The image portion which shows the highest degree of similarity is detected as a face image, or the image portions having the degrees of similarity above a threshold degree of similarity are detected as face images. This is not limited to the first exemplary, non-limiting embodiment and similarly applies to second, third, fourth, and fifth exemplary, non-limiting embodiments, all being described later.

In the first exemplary, non-limiting embodiment, retrieval of a face image has been performed through use of a type of template shown in FIG. 4. However, it is preferable to prepare a plurality of types of template image data sets and detect a face image through use of the respective types of templates. For instance, a template of a person wearing eyeglasses, a template of a face of an old person, and a template of a face of an infant, as well as a template of an ordinary person, are prepared, thereby enabling highly accurate extraction of an image of a face.

As described above, according to the present embodiment, a plurality of types of templates used for template matching are prepared, and matching operation using any of the templates is performed. Since upper and lower limit sizes of a template to be used are restrained based on information about the distance to the subject, the number of times template matching is performed can be reduced, thereby enabling high-precision, high-speed extraction of a face.

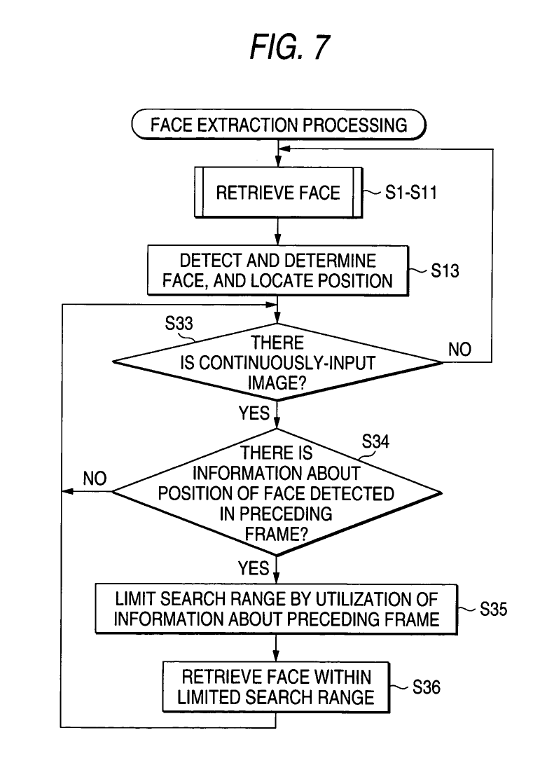

The method of the present invention that has occurred after the performance of step S13 is now described with respect to FIGS. 2 and 7. In FIG. 2, when in step S13 the position of the “face” is extracted or no face is determined, processing proceeds to step S33, where a determination is made as to whether or not there is a continuous input image as shown in FIG. 7. When there is no continuous image, processing returns to the face extracting processing shown in FIG. 2 (steps S1-S11 and optionally step S12). Specifically, when a newly-incorporated input image is different in scene from a preceding frame (i.e., a previously-input image), the face retrieval operation is performed in steps S1-S11.

When continuous images are captured one after another, the result of determination rendered in step S33 becomes positive (Y). In this case, in step S34 a determination is made as to whether or not the face of the subject has been extracted in a preceding frame. When the result of determination is negative (N), processing returns to step S1-S11, where the face extraction operation shown in FIG. 2 is performed.

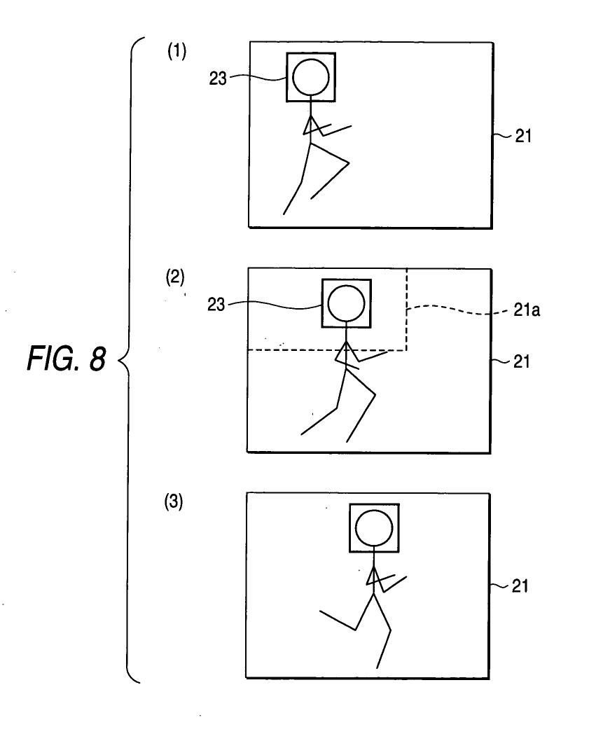

When continuous images are captured one after another and the face of the subject has been extracted in a preceding frame, the result of determination made in step S34 becomes positive (Y), and processing proceeds to step S35. In step S35, limitations are imposed on the search range of the search window 23. In the face retrieval operation shown in FIG. 2, the search range of the search window 23 has been set to the entirety of the processing image 21. When the position of the face has been detected in the preceding frame, the search range is limited to a range 21a where a face exists with high probability, as indicated by an input image (2) shown in FIG. 8.

In step S36, a face image is retrieved within the thus-limited search range 21a. Since limitations are imposed on the search range, a face image can be extracted at high speed.

After step S36, processing returns to step S33, and processing then proceeds to retrieval of a face of the next input image. In the case of autobracket photographing, which is a well-known related art photographing scheme, there are many cases where the subject stands still and remains stationary. Therefore, when a command pertaining to autobracket photographing has been input by way of the operation section 11, the search range of the face can be further limited on the input image (2) shown in FIG. 8.

When a moving subject is being subjected to continuous imaging or the like, the speed and direction of the subject can be seen from the positions of the face images extracted from the input images (1) and (2) shown in FIG. 8. For this reason, the face search range can be further restricted in an input image (3) of the next frame.

As mentioned above, in the present embodiment, when face images are extracted from a plurality of continuously-input images, the search range in the next frame can be restricted by the position of the face extracted in the preceding frame, and hence extraction of a face can be further performed at high speed. The face extraction operation pertaining to step S36 is not limited to the template matching operation but may be performed by means of another method.

(Second Embodiment)

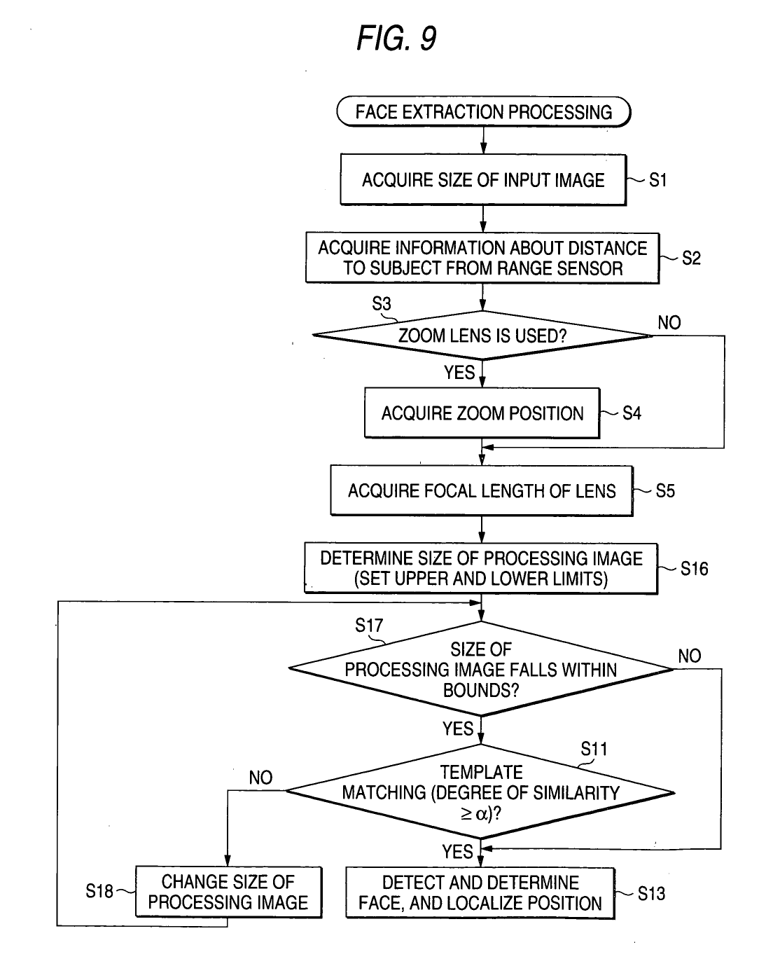

FIG. 9 is a flowchart showing processing procedures of a face extraction program according to an exemplary, non-limiting second embodiment of the invention. The digital still camera loaded with the face extraction program is substantially similar in configuration with the digital still camera shown in FIG. 1.

In the previously-described first exemplary, non-limiting embodiment, the template matching operation is performed while the size of the search window and that of the template are changed. However, in the second exemplary, non-limiting embodiment, the size of the search window and that of the template are fixed, and the template matching operation is performed while the size of the processing image 21 is being resized.

Steps S1 to S5 are substantially the same as that described in connection with the first exemplary, non-limiting embodiment in FIG. 2. The description of these steps is not repeated. Subsequent to step S5, upper and lower limitations on the size of the processing image 21 are determined (step S16). In the next step S17, a determination is made as to whether or not the size of the processing image 21 falls within the range defined by the upper and lower limitations.

When in step S17 the size of the processing image 21 is determined to fall within the range defined by the upper and lower limitations, processing proceeds to step S1, where a determination is made as to whether or not there exists an image portion whose degree of similarity is equal to or greater than the threshold value α, by means of performing template matching. When the image portion whose degree of similarity is equal to or greater than the threshold value α has not been detected, processing returns from step S11 to step S18, where the processing image 21 is resized and template matching operation is repeated. When the image portion whose degree of similarity is equal to or greater than the threshold value a has been detected, processing proceeds from step S11 to the face detection determination operation pertaining to step S13, where the position of the face is specified, and information about the position is output to the control circuit 10, to thus complete the face detection operation.

After the size of the processing image has been changed from the upper limit value to the lower limit value by resizing of the processing image 21 (or from the lower limit value to the upper limit value), the result of determination made in step S17 becomes negative (N). In this case, processing proceeds to step S13, where “no face” is determined as discussed above with respect to step S13 in FIG. 2.

As mentioned above, in the second exemplary, non-limiting embodiment, the size of the subject's face with reference to the input image is limited on the basis of the information about the distance to the subject. Hence, the number of template matching operations can be diminished, thereby enabling high-precision, high-speed extraction of a face. Further, all that is required is to prepare only one template beforehand, and hence the storage capacity of the template can be curtailed.

(Third Embodiment)

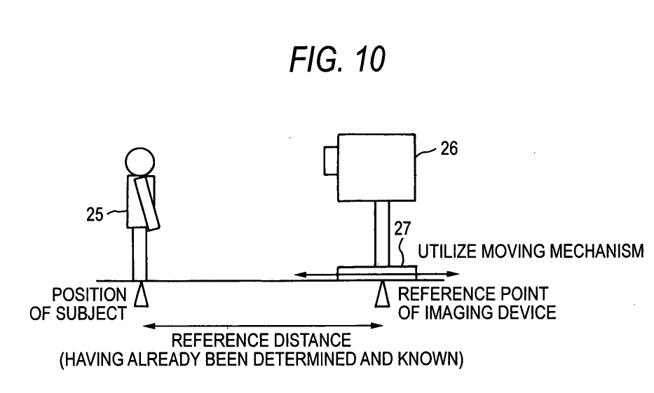

FIG. 10 is a descriptive view of a digital still camera according to a third exemplary, non-limiting embodiment of the present invention. In the first and second exemplary, non-limiting embodiments, information about a distance to the subject is acquired by the range sensor 16. However, in the third exemplary, non-limiting embodiment, information about a distance to a subject is acquired without use of a range sensor, and a face is extracted by means of template matching.

For instance, when a memorial photograph of a subject is acquired by means of a digital still camera installed in a studio or when the position where a camera such as a surveillance camera is installed and the location where an object to be monitored (e.g., an entrance door) is installed are fixed, a distance between a subject 25 and a digital still camera 26 is already known. When a mount table 27 of the digital still camera 26 is moved by a moving mechanism such as a motor and rails, the extent to which the mount table is moved is acquired by a motor timing belt, a rotary encoder, or the like. As a result, the control circuit 10 shown in FIG. 1 can as certain the distance to the subject 25, because this distance is already known.

When compared with the configuration of the digital still camera shown in FIG. 1, the digital still camera of the present invention does not have any range sensor, but instead has a mechanism for acquiring positional information from the moving mechanism.

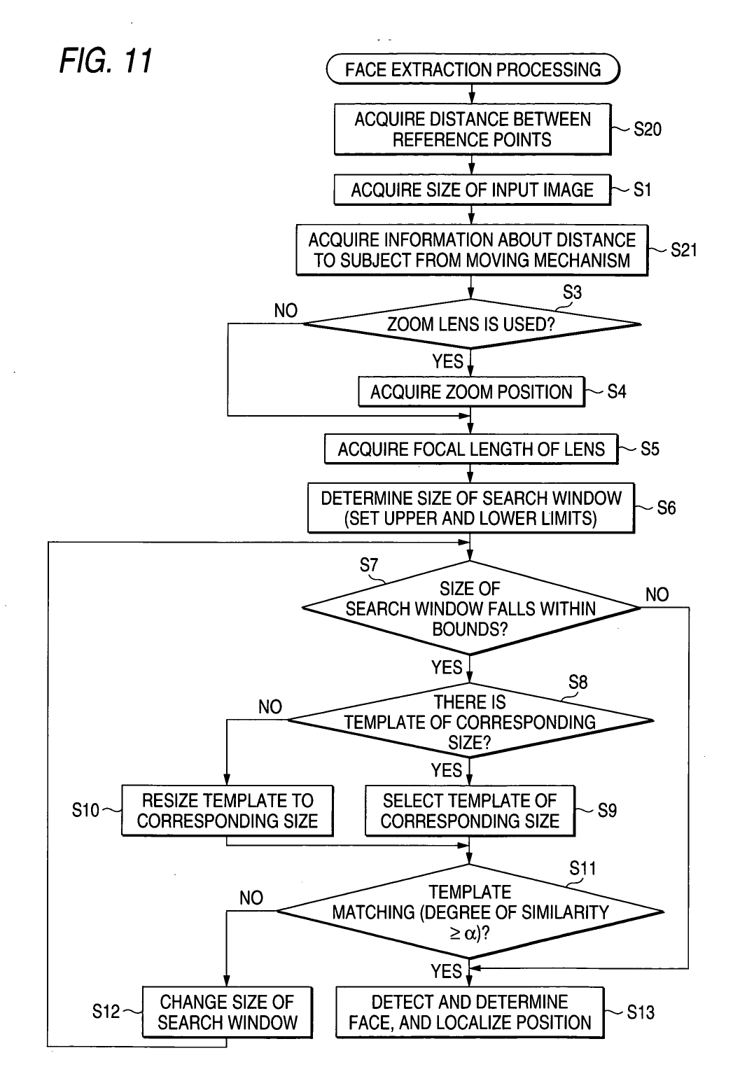

FIG. 11 is a flowchart showing processing procedures of a face extraction program of the present exemplary, non-limiting embodiment. According to the face extraction program of the present exemplary, non-limiting embodiment, information about a distance between reference points shown in FIG. 10 (i.e., a default position where the camera is installed and the position of the subject) is acquired at step S20, and the size of an input image is acquired, as in the case of step S1 of the first exemplary, non-limiting embodiment.

In the next step S21, information about the extent to which the moving mechanism has moved with reference to the subject 25 is acquired from the control circuit 10, and processing proceeds to step S3. Processing pertaining to steps S4 to S13 is identical with the counterpart processing shown in FIG. 2 in connection with the first exemplary, non-limiting embodiment, and hence its explanation is omitted.

As mentioned above, even in the present embodiment, the size of the subject's face with reference to the input image is limited based on at least the information about the distance to the subject. Hence, the number of template matching operations can be diminished, thereby enabling high-precision, high-speed extraction of a face.

(Fourth Embodiment)

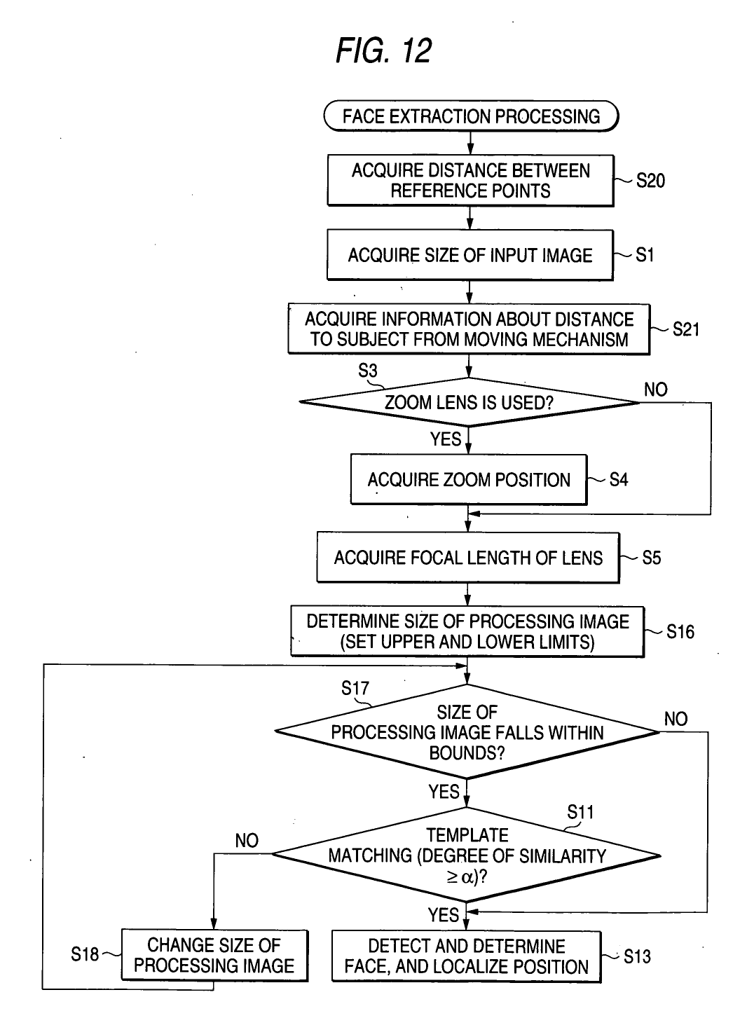

FIG. 12 is a flowchart showing processing procedures of a face extraction program according to a-fourth exemplary, non-limiting embodiment of the present invention directed to a set of instructions applied to a surveillance camera or the like, as described by reference to FIG. 10. Information about a distance between the reference points shown in FIG. 10 is acquired (step S20), and the size of an input image is acquired, as in the case of step S1 of the second embodiment.

In the next step S21, information about the extent to which the moving mechanism has moved with reference to the subject 25 is acquired from the control circuit 10, and processing proceeds to step S3. Processing pertaining to steps S3-S5, S11, S13 and S16-S18 are substantially similar to those of FIG. 9, and hence their explanation is omitted.

As mentioned above, in the present embodiment, the size of the subject's face with reference to the input image is limited on the basis of the information about the distance to the subject. Hence, the number of template matching operations can be diminished, thereby enabling high-precision, high-speed extraction of a face. Further, all that is required is to prepare only one template beforehand, and hence the storage capacity of the template can be curtailed.

(Fifth Embodiment)

Although in the previous embodiments image data pertaining to templates have been used as verification data pertaining to an image of a characteristic portion, comparison and verification can be performed through use of an image cut by the search window and without use of the image data pertaining to templates.

For example, there are prepared verification data formed by converting density levels of respective pixels of a template image shown in FIG. 4 into numerals in association with coordinates of positions of the pixels. Comparative verification can be performed through use of the verification data. Alternatively, a correlation relationship between the positions of pixels having high density levels (the position of both eyes in FIG. 4) may be extracted as verification data, and comparative verification may be performed through use of the verification data.

In the present embodiment, a learning tool such as a computer is caused beforehand to learn an image of a characteristic portion; e.g., a characteristic of a face image, in relation to an actual image photographed by an imaging device, through use of, e.g., a machine learning algorithm such as a neural network and a genetic algorithm, other filtering operations or the like, and a result of learning is stored in memory of the imaging device as verification data. In the related, such learning tools may include those commonly known in the related art as “artificial intelligence” and any equivalents thereof.

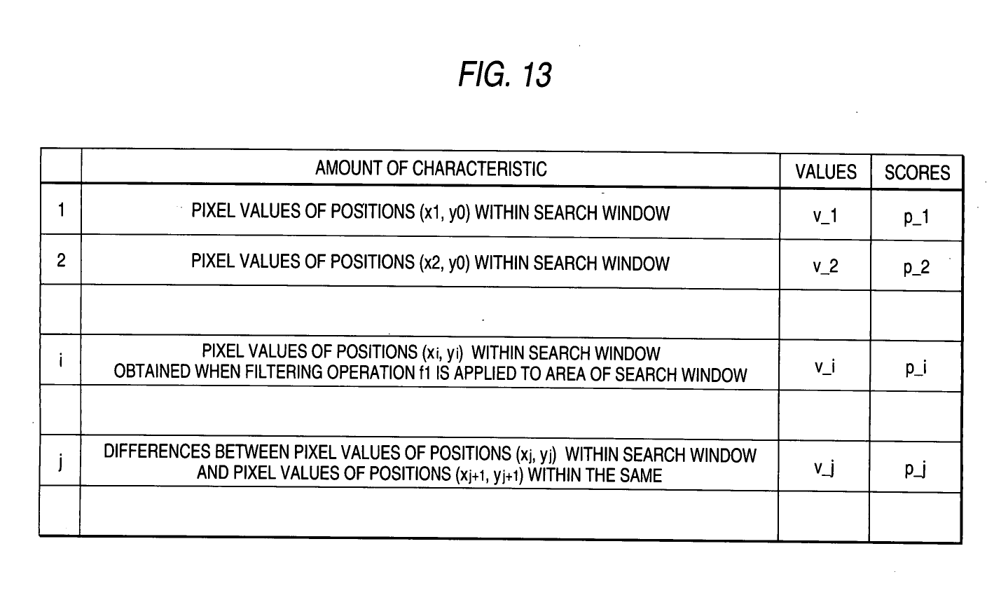

FIG. 13 is a view showing an exemplary, non-limiting configuration of the verification data obtained as a result of advanced learning operation. Pixel values v_i and scores p_i are determined through learning for respective positions of the pixels within the search window. Here, the pixel values correspond to digital data; e.g., pixel density levels. Further, scores correspond to evaluation values.

An evaluation value obtained at the time of use of a template image corresponds to a “degree of similarity” and also to an evaluation value obtained as a result of comparison with the entire template image. In the case of the verification data of the present embodiment, evaluation values are set on a per-pixel basis with reference to the size of the search window.

For instance, when a pixel value of a certain pixel is “45” a score is “9” wherein the image is set to be have a strong likelihood of including a face. In contrast, when the pixel value of another pixel is “10” a score is “−4”, wherein the image is set to have little likelihood of including a face.

A face image can be detected by means of determining an accumulated evaluation value of each pixel as a result of comparative verification and determining, from the accumulated values, whether or not the image is a face image. In the case of verification data using the numeral (or digital) data, verification data are preferably prepared for each size of the search window, to thus detect a face image on the basis of the respective verification data sets.

When a certain search window has been selected and verification data corresponding to the size of that search window have not yet been prepared, processing corresponding to that pertaining to step S1 shown in FIG. 2 in the case of the template embodiment may be performed, to thus prepare verification data corresponding to the size of the search window. For example, a plurality of verification data sets substantially close to the size of the search window are used, to thus determine pixel values through interpolation.

Here, the template corresponds to data prepared by extracting the amount of characteristic from the image of the characteristic portion as an image, and the verification data that have been converted into numerals correspond to data prepared by extracting the amount of characteristic from the image of the characteristic portion as numeral data. Therefore, there may also be adopted a configuration, wherein verification data—which describe as statements rules to be used for extracting the amount of a characteristic from the image of the characteristic portion—are prepared, and wherein an image cut off from the image to be processed by means of the search window may be compared with the verification data. Although in this case the processing device of the control circuit must interpret the rules one by one, high-speed processing will be possible, because the range of size of the face image is limited by the distance information.

Although the respective embodiments have been described by means of taking a digital still camera as an example, the present invention can also be applied to another digital camera, such as a digital camera embedded in a portable cellular phone or the like, or a digital video camera for capturing motion pictures. Moreover, the information about the distance to the subject is not limited to a case where values measured by the range sensor or known values are used, and any method may be employed for acquiring the distance information. In addition, an object to be extracted is not limited to a face, but the present invention can also be applied to another characteristic portion.

The characteristic extraction program described in connection with the respective embodiments is not limited to a case where the program is loaded in a digital camera. A characteristic portion of the subject can be extracted with high accuracy and at high speed by means of loading the program in, e.g., a photographic printer or an image processing apparatus. Further, data other than that of images may be-processed, for example but not by way of limitation, in the fields of pattern recognition and/or biometrics, as known by those skilled in the art.

In the above-described exemplary, non-limiting embodiments of the present invention, various steps are provided for processing input data, for example from an imaging device. The steps of these methods may be embodiments as a set of instructions stored in a computer-readable medium. For example, but not by way of limitation, the foregoing steps may be stored in the controller 10, face extraction processor 12, or any other portion of the device where one skilled in the art would understand that such instructions could be stored. Further, the instructions need not be stored in the device itself, and the program may be a module stored in a library and accessed remotely, by either a wireless or wireline communication system. Such a remote system can further reduce the size of the device.

Alternatively, the program may be stored in more than one location, such that a client-server relationship exists between the imaging device and a processor. For example, various steps may be performed in the face extraction processor 12, and other steps may be performed in the controller 10. Still other steps may be performed in an external server, such as in a distributed or centralized server system.

Additionally, where substantially large amounts of data are involved, the databases for the templates may be stored in a remote location and accessed by more than one imaging device at a time.

In this case, there arises a necessity for distance information and zoom information in order to limit the size of the template or the size of the processing image to the range defined by the upper and lower limitations of an image of a characteristic portion. However, it is better to use, as that information, information appended to photography data as tag information by the camera that has captured the input image. Further, it is better to utilize the tag information appended to the photography data when a determination is made as to whether images have been taken through autobracket photographing or continuous firing.

In the previously-described embodiment, a limitation is imposed on the range of size of a characteristic portion included in an image, on the basis of information about a distance to a subject determined by the range sensor, the number of motor drive pulses required to bring a subject into the focus of the photographing lens, or the like. Even when the range of size of the characteristic portion is not ascertained accurately, the present invention is applicable, so long as a rough range can be determined.

For instance, a distance to a subject can be roughly limited on the basis of a focal length of the photographing lens. Further, if a photographing mode in which photographing has been performed, such as a portrait photographing mode, a landscape photographing mode, or a macro photographing mode, is ascertained, a distance to a subject can be estimated. An attempt can be made to speed up characteristic portion extraction processing by means of roughly limiting the size of a characteristic portion.

Moreover, a rough distance to a subject can be estimated or determined by combination of these information items; for instance, a combination of a photographing mode and a focal length of a photographing lens, or a combination of a photographing mode and the number of motor drive pulses.

The present invention enables high-speed extraction of an image of a characteristic portion, such as a face, from an input image. Hence, corrections to be made on local areas within an image; for instance, brightness correction, color correction, contour correction, halftone correction, imperfection correction, or the like, as well as corrections to be made on the entire image, can be performed at high speed. Loading of such a program in an image processing device and an imaging device is preferable.

According to the present invention, the size of an image to be cut for comparison with verification data is limited to the size range of an image of a characteristic portion. Hence, the number of times comparison is performed decreases, and an attempt can be made to speed up processing and increase precision.

In addition, according to the present invention, when characteristic portions of a subject are extracted from continuously-input images, a search range is limited by utilization of information about the characteristic portions extracted in a preceding frame, and hence extraction of the characteristic portions can be speeded up and made more accurate.

The entire disclosure of each and every foreign patent application from which the benefit of foreign priority has been claimed in the present application is incorporated herein by reference, as if fully set forth.

What is claimed is:

1. A method for detecting whether an image of a characteristic portion exists in an image to be processed, comprising:
sequentially cutting images of a required size from the image to be processed; and
comparing the cut images with verification data corresponding to the image of the characteristic portion,
wherein a limitation is imposed on a size range of the image of the characteristic portion with reference to the size of the image to be processed, based on information about a distance between a subject and a location of imaging the subject, obtained when the image to be processed has been photographed, thereby limiting the size of the cut images to be compared with the verification data.

2. The method according to claim 1, wherein the limitation is effected through use of information about a focal length of a photographing lens in addition to the information about a distance to the subject.

3. The method according to claim 1, wherein the comparison is performed through use of a resized image into which the image to be processed has been resized.

4. The method according to claim 3, wherein the comparison is effected through use of the verification data corresponding to the image of a characteristic portion of determined size by changing a size of the resized image.

5. The method according to claim 3, wherein the comparison is effected through use of the verification data, the data being obtained by changing the size of the image of the characteristic portion while the size of the resized image is fixed.

6. The method according to claim 1, wherein the verification data comprises template image data pertaining to the image of the characteristic portion.

7. The method according to claim 1, wherein the verification data comprises data prepared by converting an amount of characteristic of the image of the characteristic portion into digital data.

8. The method according to claim 1, wherein the verification data is formed from data upon which at least one rule for extracting the amount of the image of the characteristic portion has been applied.

9. The method comprising limiting a range in which an image of a characteristic portion of a second image to be processed followed by a first image to be processed, is retrieved through use of information about a position of a characteristic portion extracted from the first image, the information being obtained by the method according to claim 1.

10. A computer-readable medium including set of instructions for detecting whether an image of a characteristic portion exists in an image to be processed, the set of instructions comprising:
sequentially cutting images of a required size from the image to be processed; and
comparing the cut images with verification data pertaining to the image of the characteristic portion,
wherein the program includes limiting a size range of the image of the characteristic portion with reference to the size of the image to be processed based on information about a distance between a subject and a location of imaging of the subject that is obtained when the image to be processed has been photographed, to limit the size of the cut images.

11. The computer readable medium including the set of instructions of claim 10, the instructions further comprising limiting a range in which an image of a characteristic portion of a second image to be processed followed by a first image to be processed is retrieved, through use of information about a position of a characteristic portion extracted from the first image.

12. The computer readable medium including the set of instructions of claim 10, wherein the computer readable medium having the instructions is positioned in at least one of an imaging device and an image processing device.

13. The computer readable medium including the set of instructions of claim 10, wherein the distance information used when the instructions execute the limiting corresponds to distance information added to the image to be processed as tag information.

14. The computer readable medium including the set of instructions of claim 10, further comprising the following instruction: determining the distance information required at the time of execution of the limiting by the instructions.

15. The computer readable medium including the set of instructions of claim 14, wherein the determining instruction is performed by at least one of a range sensor, a unit for counting a number of motor drive pulses arising when the focus of a photographing lens is set on a subject, a unit for determining information about a focal length of a photographing lens, a unit for estimating a distance to the subject based on a photographing mode and a unit for estimating a distance to the subject based on a focal length of a photographing lens.

16. The computer readable medium including the set of instructions of claim 10, wherein the set of instructions further comprises subjecting the verification data to an artificial intelligence system.

17. The computer readable medium of claim 16, wherein the artificial intelligence system comprises at least one of a neural network and a genetic algorithm applied to the verification data to provide learned recognition for the image of the subject.

18. A data collection and processing device, comprising:
a processor that converts input data of a subject as received by a data capture element into a machine-readable data and performs at least one of synchronization and correction processing on the machine-readable data;
a controller that performs a first command signal and a second command signal; and
an extractor that extracts a characteristic portion from the machine-readable, processed data in response to a first command signal from the controller;
wherein distance information between the subject and the data capture element in response to a second command signal from the controller is received by the device, and wherein the distance information is applied to the processed data, and further wherein the processed data is iteratively manipulated based on a result of a comparison with reference data.

19. The device of claim 18, wherein the distance information is one of (a) obtained by a ranging sensor that measures a distance between the subject and the data capture element, and (b) a predetermined distance value.

20. The device of claim 18, wherein the reference data comprises copies of previously captured ones of the input data, and the result comprises a determination as to whether the reference data substantially matches the processed input data.

21. The device of claim 18, wherein a scale of the processed input data is manipulated with respect to the reference data to generate a processed input data having a scale with a prescribed range with respect to the reference data.
